(19) United States
(12) Patent Application Publication
(10) Pub. No.: US 2016/0031017 A1
(43) Pub. Date: Feb. 4, 2016

(54) TOOL BIT HOLDER FOR POWER TOOL

(71) Applicant: BLACK & DECKER INC., Newark, DE (US)

(72) Inventors: Michael P. PETERS, Lutherville, MD (US); Aland SANTAMARINA, Columbia, MD (US)

(21) Appl. No.: 14/800,734

(22) Filed: Jul. 16, 2015

Related U.S. Application Data
(60) Provisional application No. 62/031,478, filed on Jul. 31, 2014.

(51) Int. Cl. B23B 51/12; B23B 45/00

(52) U.S. Cl. CPC B23B 51/12; B23B 45/003; B23B 2231/04; B23B 2231/022; B23B 2231/026; B23B 2231/48

(57) ABSTRACT

A tool bit holder releasably retains a shank of a tool bit having three flat faces arranged generally in a triangle and an annular groove. A holder body has a shank-receiving bore bounded by an inner wall with three flat inner wall surfaces arranged generally in a triangle. A plurality of windows, defined in the inner wall, extend radially outward from the bore. A plurality of retaining members is received in the plurality of windows and extends at least partially through the window into the bore. An elastic band around the retaining members biases the retaining members radially inward toward the bore. The flat wall portions are configured to engage the flat faces of the tool bit to non-rotationally retain the shank in the tool holder and the retaining members are configured to engage the annular groove to axially retain the tool bit in the tool holder.

### RELATED APPLICATIONS

This application claims priority, under 35 U.S.C. §119(e) to U.S. Provisional Application No. 62/031,478, filed Jul. 31, 2014, titled “Tool Bit Holder for Power Tool,” which is hereby incorporated by reference.

### TECHNICAL FIELD

This application relates to tool bit holders for power tools.

### BACKGROUND

Referring to FIGS. 1-14, U.S. Pat. No. 6,474,656, which is incorporated herein by reference, discloses a chuck 30 that can be coupled to a power driver such as, for example, a drill 32, shown in phantom, for rotating the chuck. The chuck 30 is designed with a triangular shaped shank-receiving opening or bore 34 for receiving and locking differently configured shanks of a plurality of accessories, including, for example, (1) a bit 36 (FIG. 2) having a hexagonal shank 38, with a groove 40, (2) a bit 42 (FIG. 3) having a triangular cross-sectioned shank 44 formed with slightly convex surfaces 46 (FIG. 12) at corners of the triangular cross section, and with a groove 48, and (3) a bit 50 (FIG. 4) having a triangular cross-sectioned shank 52, with a groove 54.

The shanks 38, 44 and 52 of the three bits 36, 42 and 50, respectively, may also be received and gripped by chucks having other shank-receiving openings such as, for example, the illustrated front-face openings 56, 58, 60 and 62 of chucks 64, 66, 68 and 70, respectively, as shown in FIGS. 8, 9, 10 and 11, respectively. The shanks 38, 44 and 52 may also be received in the various shank-receiving openings of the chucks disclosed in a now abandoned patent application identified by U.S. Ser. No. 60/108,336, filed on Nov. 13, 1998, and its successor nonprovisional patent application identified by U.S. Ser. No. 09/439,505, filed on Nov. 12, 1999, the disclosures of which are incorporated herein by reference thereto.

Referring to FIG. 14, the chuck 30 includes a chuck body 72, an end cap 74 and a sleeve 76. The chuck body 72 is formed integrally in three sections identified as a forward section 78 having a first exterior diameter, an intermediate section 80 having a second exterior diameter greater than the first diameter, and a rearward section 82 having a third exterior diameter less than the first diameter. The shank-receiving opening 34 is formed axially in the forward section 78 from a front face 84 thereof for a distance equal to about three-fourths of the axial length of the forward section.

A passage 86 is formed through the forward section 78 between an exterior peripheral surface 88 thereof and into communication with the opening 34. The passage 86 is formed at an angle relative to the axis of the chuck 30 and extends from the juncture thereof with the peripheral surface 88, toward the axis and the front face 84. The passage 86 is sized to receive a ball 90 for movement therein.

The sleeve 76 is formed with a bore 92 which is located about the peripheral surface 88 of the body 72 to allow axial movement of the sleeve relative to the body. The sleeve 76 is formed with a counterbore 94, portions of which are located about an exterior peripheral surface 96 of the intermediate section 80 for axial movement relative thereto. A counterbore base surface 98 is formed in the sleeve 76 and, together with the counterbore 94, the peripheral surface 88 and a forward surface 100 of the intermediate section 80, defines an enclosed chamber 102 for receipt of a spring 104. The end cap 74 is press fit onto a forward portion of the peripheral surface 88 of the body 72, whereby the sleeve 76 is captured in the assembled arrangement, as illustrated, but can be moved axially relative to the body for a limited axial distance.

The rearward section 82 of the body 72 forms a stem or shank which can be assembled and gripped within the drill 32 to facilitate rotation of the chuck 30 when the drill is operated. Alternatively, the rearward section 82 could be formed with a threaded axial bore from the rear thereof to facilitate the mounting of the chuck 30 onto a threaded spindle of the drill 32.

Referring to FIG. 7, two interfacing, spaced slots 106 and 108 are formed in opposite wall portions of the passage 86. Each of the slots 106 and 108 extend from the opening of the passage 86, which is contiguous with the peripheral surface 88 of the chuck body 72, to a squared floor 110, near the juncture of the passage with the opening 34. As shown in FIG. 5, a forward corner of the squared floor 110 of each of the slots 106 and 108 slightly overlaps the counterbore base surface 98 of the sleeve 76. As shown in FIG. 6, the slots, represented in the figure by the slot 106 is formed at the same forward, axially-directed angle as the passage 86.

Referring to FIGS. 5, 13 and 14, the ball 90 is formed with a through hole 112 for receiving an intermediate portion of a pin 114, which extends from opposite sides of the ball by equal distances. As shown in FIG. 13, opposite ends of the pin 114 extend to a location where the ends overlap the base surface 98 and, as illustrated in FIG. 5, are also located in the floor 110 of the slots 106 and 108 when the ball 90 is positioned so that a small portion 90 a of the ball extends into the opening 34. In this position, the spring 104 is resting on the adjacent portions of the pin 114 to normally urge the pin into engagement with the floor 110 of each of the slots 106 and 108, and into engagement with adjacent portions of base surface 98 of the sleeve 76. This provides a means for normally urging the ball 90 into a position where the portion 90 a of the ball extends into the opening 34.

When using the chuck 30, an operator inserts, for example, the rearward end of the shank 52 (FIG. 4) of the bit 50 into the triangular opening 34 of the chuck. Upon continued insertion movement of the bit 50, the rearward end of the shank 52 engages a means for locking the shank with the chuck 30, including the ball 90 and the portion 90 a thereof, and urges the ball fully into the passage 86, which allows continued insertion movement of the bit. Eventually, the groove 54 of the bit 50 becomes aligned with the passage 86 and the biasing force of the compressed spring 104 urges the ball 90, as a locking element, further into the passage whereby the portion 90 a enters the groove 54 to effectively lock the bit 50 with chuck 30 through the action of the means for locking.

In order to remove the bit 50 from the chuck 30, the operator retracts the sleeve 76, whereby the base surface 98 of the sleeve is moved rearward of the chuck to move the ends of the pin 114 angularly rearward within the slots 106 and 108. Eventually, upon the angularly rearward movement of the ball 90, the portion 90 a thereof is withdrawn into the passage 86 and the bit 50 can now be removed from the chuck 30.

Referring to FIG. 12, a solid line triangle forms the perimeter of the figure and represents the triangular opening 34 of the chuck 30, on the one hand, and also represents the triangular shank 52 (FIG. 4) of the bit 50, on the other hand, with the shank being inserted into the opening. The dashed line triangle within the solid line triangle represents the groove 54 of the bit 50.

Major portions of the solid line triangle also represent the shank 44 (FIG. 3) of the bit 42, with the convex surfaces 46 also being shown, all of which are located with the opening 34. The dashed line triangle also represents the groove 48 of the bit 42.

Further, three solid line surfaces of the hex configuration of the shank 38 (FIG. 2) of the bit 36 are shown in overlapping arrangement with intermediate portions of respective sides of the solid lines which represent the opening 34. The three solid lines, which represent the remaining three sides of the shank 38, are shown within the solid line representation of the opening 34. The dashed line circle in the center of FIG. 12 represents the groove 40 of the bit 36.

### SUMMARY

In one aspect, this application relates to a tool bit holder for receiving and retaining a shank of a tool bit having three flat faces arranged generally in a triangle and an annular groove. The tool bit holder includes a holder body that includes a shank-receiving bore bounded by an inner wall having three flat inner wall surfaces arranged generally in a triangle. A plurality of windows each extends radially outward from the bore through the inner wall. The plurality of windows each receives a retaining member that extends at least partially through the window into the bore. An elastic band surrounds the retaining members and biases the retaining members radially inward toward the bore. The flat wall portions of the bore are configured to engage the flat faces of the tool bit to non-rotationally retain the shank of the tool bit in the tool holder. The retaining member is configured to engage the annular groove of the tool bit to axially retain the tool bit in the tool holder.

Implementations of this aspect may include one or more of the following features. The inner wall may include concave wall surfaces at corners of the triangle formed by the inner wall surfaces to engage convex wall surfaces at corners of the triangle formed by the flat faces of the tool bit. The windows may be tapered. The retaining member may be a pin or a ball. The holder body may have an outer surface with an annular recess that receives the elastic band. The tool bit holder may include a shank portion configured to be retained in a chuck or tool bit holder of a power tool. The shank portion may include a polygonal shank with an annular groove.

In another aspect, this application relates to a tool bit holder for receiving and retaining shanks of two different tool bits having different diameters, each shank having three flat faces arranged generally in a triangle and an annular groove. The tool bit holder includes a holder body that includes a shank-receiving bore having a front large diameter section and a rear small diameter section. Each section is bounded by an inner wall having three flat inner wall surfaces arranged generally in a triangle. A first window extends radially outward from the large diameter section of the bore through the inner wall. A second window extends radially outward from the small diameter section of the bore through the inner wall. The first window receives a retaining member that extends at least partially through the first window into the large diameter section of the bore. The second window receives a second retaining member that extends at least partially through the second window into the small diameter section of the bore. A first elastic band surrounds the first retaining member and biases the first retaining member radially inward toward the bore. A second elastic band surrounds the second retaining member and biases the second retaining member radially inward toward the bore. The flat wall portions of the first section of the bore are configured to engage flat faces of a large diameter tool bit while the first retaining member engages the annular groove in the tool bit to non-rotationally and axially retain the shank of the large diameter tool bit in the large diameter section of the bore. The flat wall portions of the second section of the bore are configured to engage flat faces of a small diameter tool bit while the second retaining member engages the annular groove in the tool bit to non-rotationally and axially retain the shank of the small diameter tool bit in the small diameter section of the bore.

In another aspect, a tool bit holder releasably retains a shank of a tool bit having three flat faces arranged generally in a triangle and an annular groove. The tool bit holder includes a holder body that includes a shank-receiving bore bounded by an inner wall having three flat inner wall surfaces arranged generally in a triangle. A plurality of windows is defined in the inner wall, each window extending radially outward from the bore. A plurality of retaining members are received in the plurality of windows with each retaining member received in one of the plurality of windows and extending at least partially through the window into the bore. An elastic band is disposed around the retaining members and biases the retaining members radially inward toward the bore. The flat wall portions of the bore are configured to engage the flat faces of the tool bit to non-rotationally retain the shank of the tool bit in the tool holder and the retaining members are configured to engage the annular groove of the tool bit to axially retain the tool bit in the tool holder.

Implementations of this aspect may include one or more of the following features. The inner wall may include a concave wall surface at each junction between adjacent flat inner wall surfaces, each concave wall surface configured to engage a convex wall surface at a junction between adjacent flat faces of the tool bit. Each window may be defined in one of the concave inner wall surfaces. The windows may be tapered. Each retaining member may comprise a pin or a ball. The holder body may include an outer surface with an annular recess that receives the elastic band. A shaft may extend rearward from the holder body and may be configured to be retained in a chuck or tool bit holder of a power tool. The shaft may include a polygonal shank with an annular groove.

In another aspect, a tool bit holder releasably retains shanks of at least two tool bits, each shank having a different diameter and each shank having three flat faces arranged generally in a triangle and an annular groove. The tool bit holder includes a holder body with a shank-receiving bore having a front section with a larger diameter and a rear section with a smaller diameter, each section bounded by an inner wall having three flat inner wall surfaces arranged generally in a triangle. A first window is defined in the inner wall of the front section and extends radially outward from the front section of the bore. A second window is defined in the inner wall of the rear section and extends radially outward from the rear section of the bore. A first retaining member extends at least partially through the first window into the front section of the bore. A second retaining member extends at least partially through the second window into the rear section of the bore. A first elastic band is disposed around the first retaining member and biases the first retaining member radially inward toward the front section of the bore. A second elastic band is disposed around the second retaining member and biases the second retaining member radially inward toward the rear section of the bore. The flat wall portions of the front section of the bore are configured to engage flat faces of a first tool bit of the at least two tool bits while the first retaining member engages the annular groove in the first tool bit to axially retain the shank of the first tool bit in the front section of the bore. The flat wall portions of the rear section of the bore are configured to engage flat faces of a second tool bit of the at least two tool bits while the second retaining member engages the annular groove in the second tool bit to axially retain the shank of the second tool bit in the rear section of the bore.

Implementations of this aspect may include one or more of the following features. Each of the inner walls may include a concave wall surface at each junction between adjacent flat inner wall surfaces, each concave wall surface configured to engage a convex wall surface at a junction between adjacent flat faces of the tool bit. Each window may be defined in one of the concave inner wall surfaces. The windows may be tapered. Each retaining member may comprise a pin or a ball. The holder body may include a first outer surface with a first annular recess that receives the first elastic band, and a second outer surface with a second annular recess that receives the second elastic band. A shaft may extend rearward from the holder body and may be configured to be retained in a chuck or tool bit holder of a power tool. The shaft may include a polygonal shank with an annular groove. The first window may include a first plurality of windows and the first retaining member may include a first plurality of retaining members with each of the first plurality of windows receive one of the first plurality of retaining members.

In another aspect, a tool bit set includes a tool bit and a tool bit holder for releasably retaining the tool bit. The tool bit has a working portion and a shank coupled to a rear end of the working portion. The shank includes three flat faces arranged generally in a triangle and an annular groove. The tool bit holder includes a holder body with a shank-receiving bore bounded by an inner wall having three flat inner wall surfaces arranged generally in a triangle. A plurality of windows is defined in the inner wall. Each window extends radially outward from the bore. A plurality of retaining members are received in the windows with each retaining member received in one of the plurality of windows and extending at least partially through the window into the bore. An elastic band is disposed around the retaining members and biases the retaining members radially inward toward the bore. The flat wall portions of the bore are configured to engage the flat faces of the tool bit to non-rotationally retain the shank of the tool bit in the tool holder. The retaining members are configured to engage the annular groove of the tool bit to axially retain the tool bit in the tool holder.

Implementations of this aspect may include one or more of the following features. The shank may include a convex face at each junction between adjacent flat faces, and the inner wall may include a concave wall surface at each junction between adjacent flat inner wall surfaces, with each concave wall surface configured to engage one of the convex faces of the tool bit. Each window may be defined in one of the concave inner wall surfaces.

Advantages may include one or more of the following. The tool bit holder non-rotationally and axially retains a tool bit while allowing for quick insertion and release of the tool bit from the tool bit holder. The tool bit holder can be configured to hold two or more sizes of shanks of tool bits in the same tool bit holder. These and other advantages and features will be apparent from the detailed description and the drawings.

### BRIEF DESCRIPTION OF THE DRAWINGS

FIG. 1 is a perspective view showing the chuck of U.S. Pat. No. 6,474,656 mounted on a drill.

FIG. 2 is a perspective view showing a shank having a hexagonal cross section.

FIG. 3 is a perspective view showing a shank having a first triangular cross section.

FIG. 4 is a perspective view showing a shank having a second triangular cross section.

FIG. 5 is a partial sectional view of a body, sleeve, spring and locking element of the chuck of FIG. 1.

FIG. 6 is a side view showing the body of FIG. 5.

FIG. 7 is a plan view showing the body of FIG. 5.

FIG. 8 is a front view showing the front face of the chuck of FIG. 1 having a first embodiment of a bore configuration.

FIG. 9 is a front view showing the front face of the chuck of FIG. 1 having a second embodiment of a bore configuration.

FIG. 10 is a front view showing the front face of the chuck of FIG. 1 having a third embodiment of a bore configuration.

FIG. 11 is a front view showing the front face of the chuck of FIG. 1 having a fourth embodiment of a bore configuration.

FIG. 12 is a diagrammatical view showing a triangle representative of a bore opening of the chuck of FIG. 1 with end view representations of the shanks of FIGS. 3 and 4.

FIG. 13 is a front view showing a front face of the chuck of FIG. 1 in conjunction with the locking element of FIG. 5.

FIG. 14 is a sectional view showing the chuck of FIG. 1 with the locking element of FIG. 5 biased partially into the bore of the chuck.

FIG. 15 is a perspective view of another embodiment of a tool bit holder in accordance with the present disclosure.

FIG. 16 is a side view of the tool holder of FIG. 15.

FIGS. 17A and 17B are cross sectional views of the tool holder of FIG. 15.

FIG. 18 is a front end view of the tool holder of FIG. 15.

FIG. 19 is a side view of a drill bit for being received in the tool holder of FIG. 15.

FIG. 20 is a rear end view of the drill bit of FIG. 19.

FIG. 21 is a side view of another embodiment of a tool bit holder in accordance with the present disclosure.

FIG. 22 is a cross sectional view of the tool bit holder of FIG. 21.

FIG. 23 is a front end view of the tool bit holder of FIG. 21.

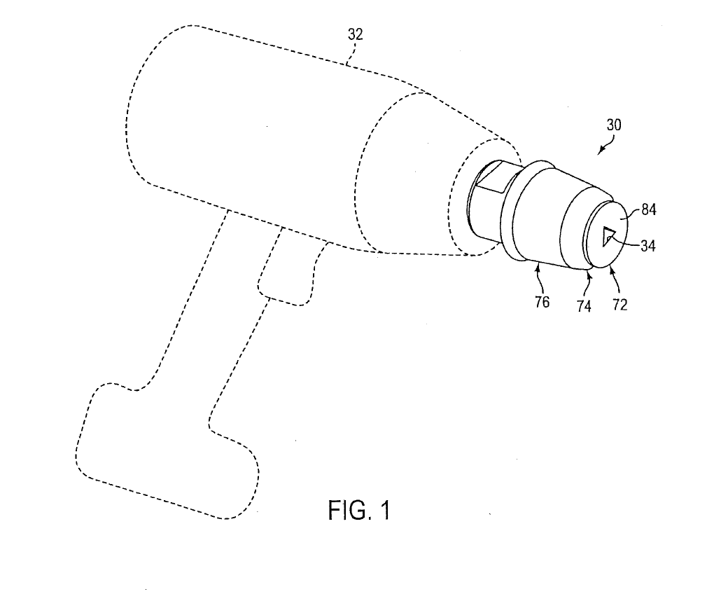

### DETAILED DESCRIPTION

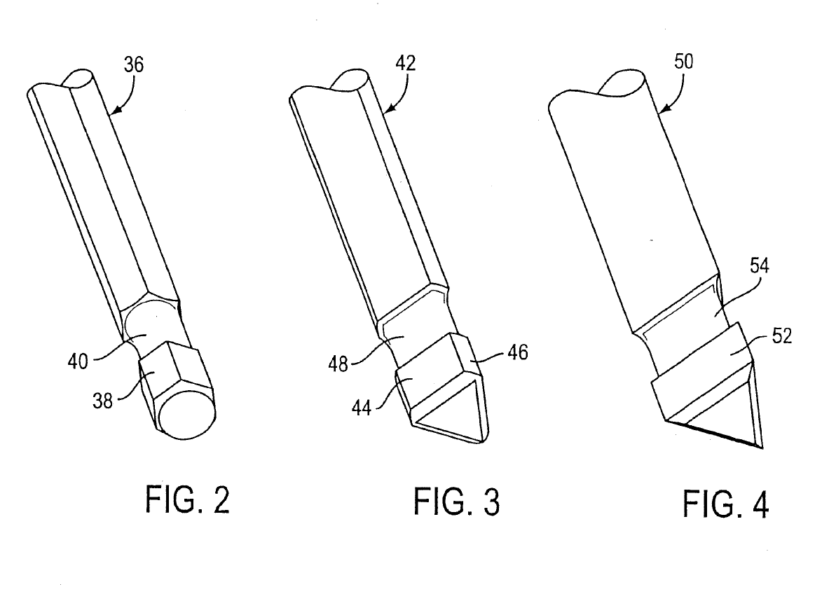

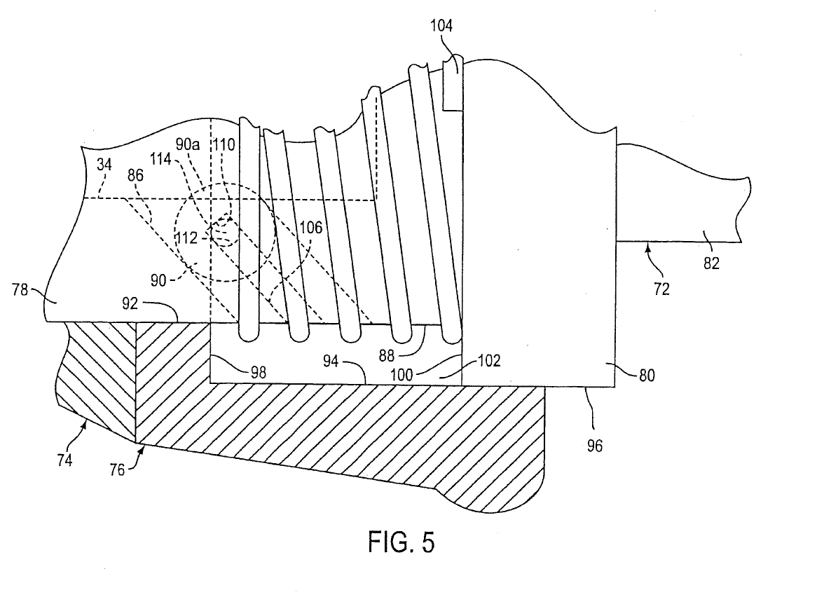

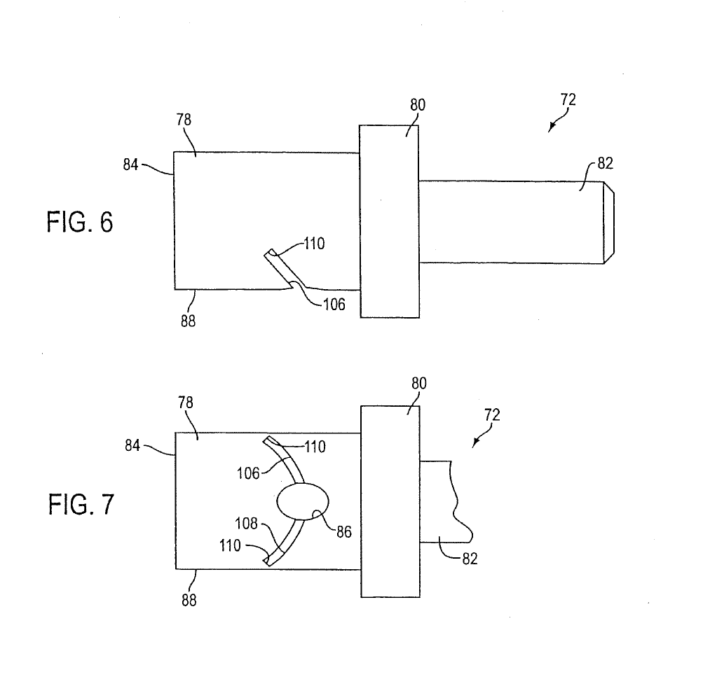

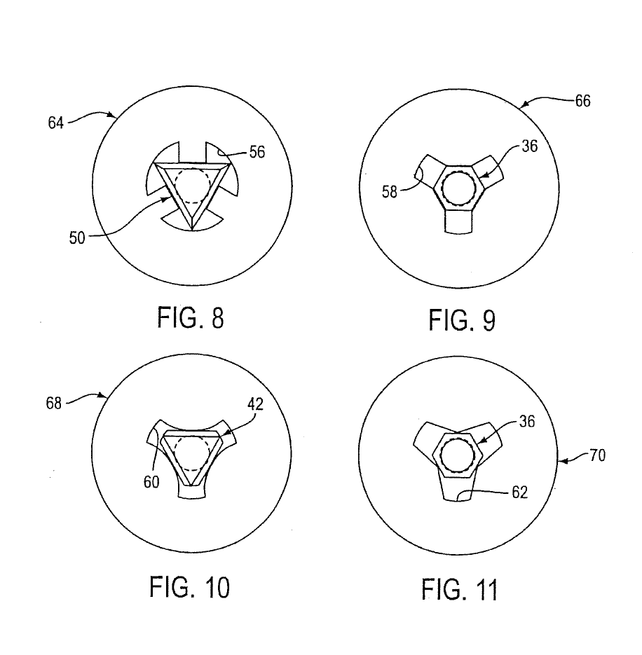

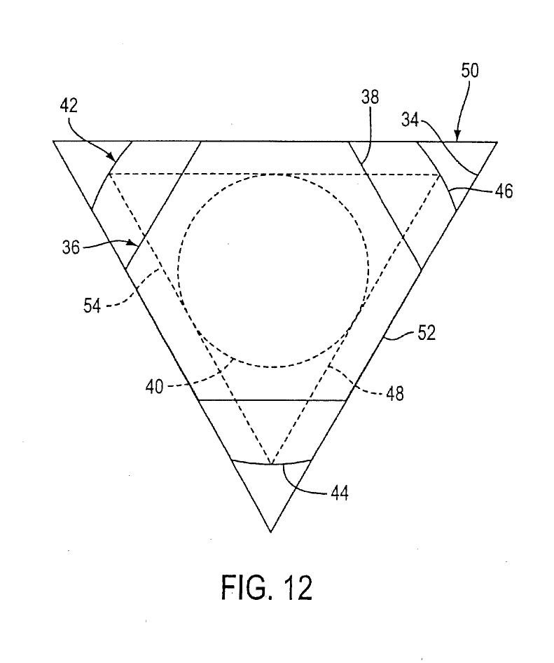

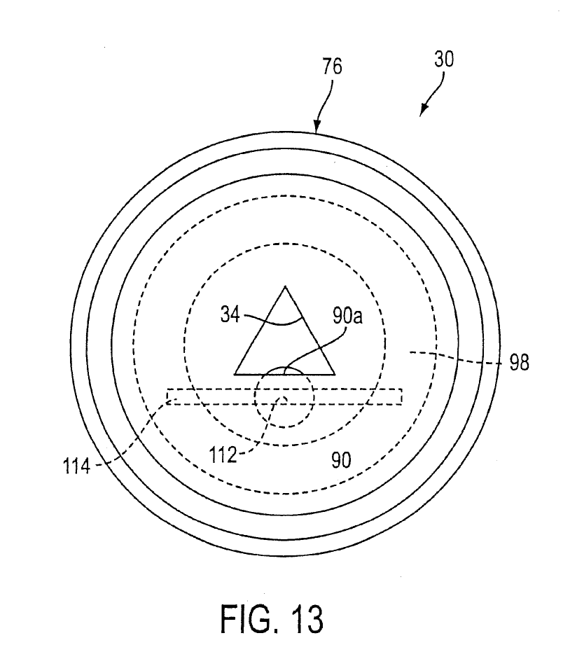

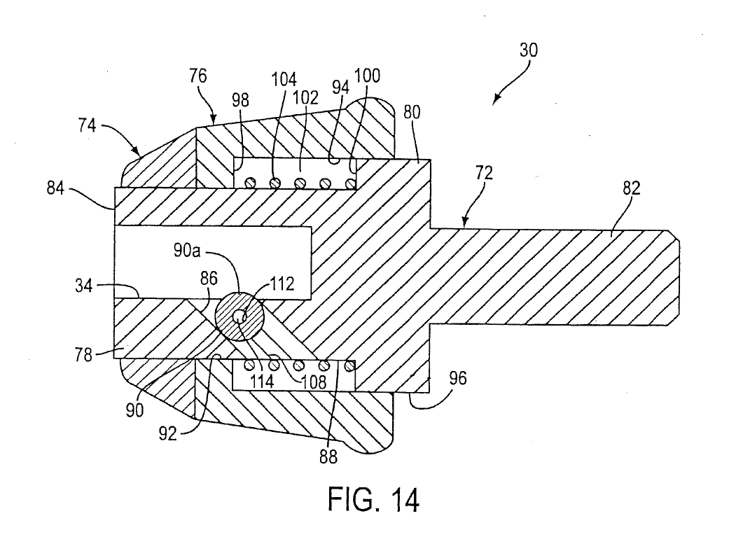

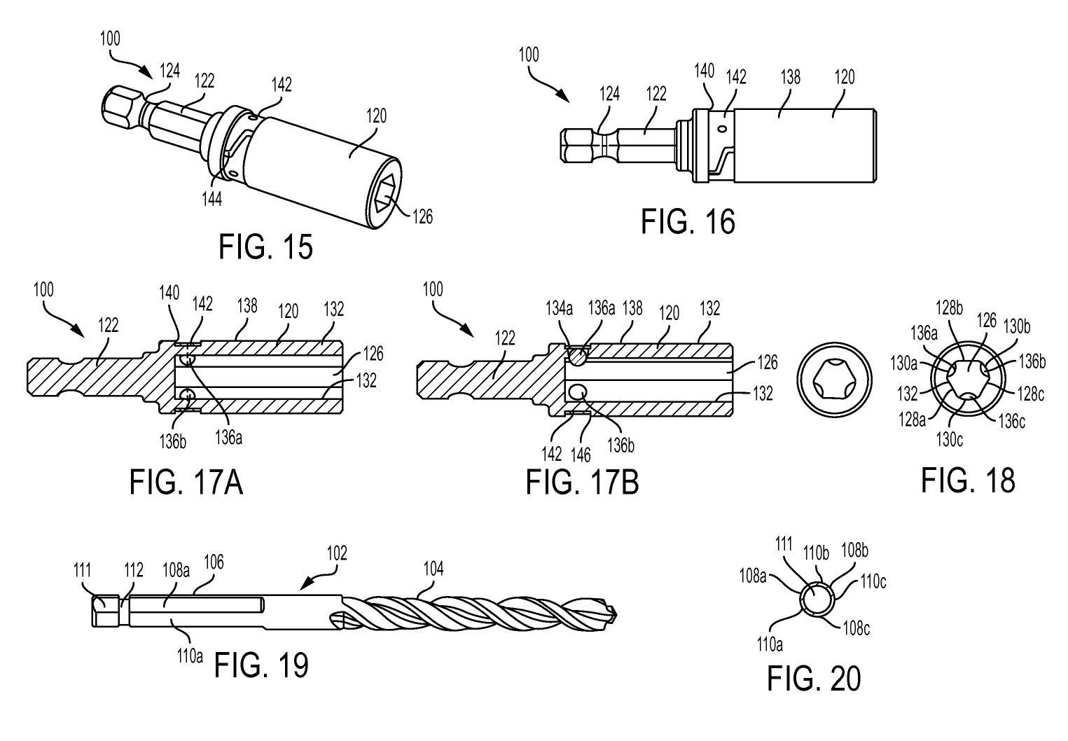

Referring to FIGS. 15-20, a tool bit holder 100 can be coupled to a power tool such as the aforementioned drill 32. The tool bit holder 100 may be configured to receive a plurality of tool bits having a shank with a polygonal cross section with an annular groove formed in the cross-section. For example, the tool bit holder 100 may be configured to receive and retain the bit 36 with a hexagonal shank and a groove 40 (FIG. 2), the bit 42 with a triangular cross-sectioned shank 44 with a groove 48 and formed with convex surfaces 46 at corners formed at junctions of the flat faces of the triangular cross-section (FIG. 12), or the bit 50 having a triangular cross-sectioned shank with a groove 54. In one particular embodiment, as shown in FIGS. 15-18, the tool bit holder 100 is configured to receive and retain a drill bit 102 having a fluted cutting portion 104 and a shank portion 106. The shank portion 106 has a cross-section with a plurality of flat walls 108a, 108b, 108c arranged in a triangle with three slightly convex surfaces 110a, 110b, 110c at corners of the triangle formed at junctions between adjacent flat walls 108a, 108b, 108c. The shank portion 106 also includes an annular groove 112.

The tool bit holder 100 includes a holder body 120 and a shank portion 122. The shank portion 122 has a polygonal cross-section (e.g., hexagonal) and an annular groove 124. The shank portion 122 is configured to be received and retained in a tool holder or chuck of a rotary power tool such as the drill 32. The holder body 120 has an inner wall 132 that defines a longitudinal bore 126 for receiving the shank 106 of the bit 102. The inner wall 132 is configured to generally match the cross-sectional shape of the shank 106. In particular, the inner wall 136 has three flat wall portions 128a, 128b, 128c arranged in a triangle with three slightly concave curved wall portions 130a, 130b, 130c at corners of the triangle formed at junctions between adjacent flat wall portions 128a, 128b, 128c.

The holder body 120 also defines three windows only one of which (134a) is shown. The windows are tapered and extend radially outward from the concave inner wall portions 130a, 130b, 130c. Each window 134a, 134b, 134c receives a retaining member in the form of a pin or a ball 136a, 136b, 136c that extends at least partially through the window 134a, 134b, 134c into the bore 126. The holder body 120 also includes a substantially cylindrical outer wall 138 with an annular groove 140. The annular groove 140 receives a substantially cylindrical elastic band 142 that abuts and biases the balls 136a, 136b, 136c radially inwardly toward the bore 126. The elastic band 142 may include a split 144 to facilitate attaching the elastic band 142 to the holder body 120.

In use, the shank 106 of the bit 102 is inserted into the bore 126 with the flat walls 110a, 110b, 110c of the shank 102 aligned with the flat wall portions 128a, 128b, 128c of the inner wall 132. The rear end portion 111 of the shank 106 pushes the balls 136a, 136b, 136c radially outward against the force of the elastic band 142. When the annular groove 112 of the shank 106 is aligned with the balls 136a, 136b, 136c, the elastic band 142 pushes the balls radially inward to engage the annular groove 112. The balls 136a, 136b, 136c axially retain the bit 102 in the bore 126, while the flat wall portions 128a, 128b, 128c non-rotationally retain the bit 102 in the bore. Thus, rotational motion of the holder 100 can be transmitted to the bit 102 without the bit 102 moving relative to the holder 100.

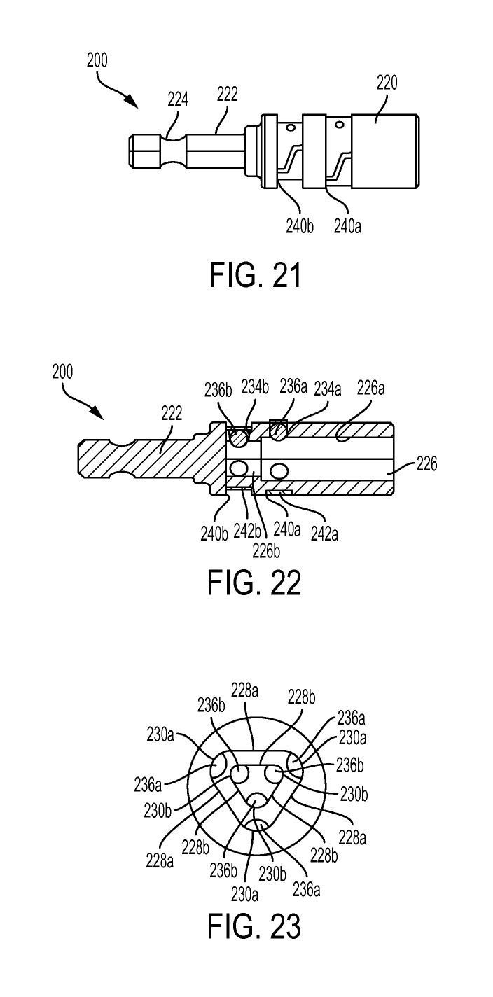

Referring to FIGS. 21-23, in another embodiment, a tool bit holder 200, similar to tool bit holder 100, may be configured to receive a plurality of tool bits having shanks with different sized polygonal cross sections. For example, the tool bit holder 200 may be configured to receive and retain the two different drill bits 102 having different diameter shank portions 106. The tool bit holder 200 includes a holder body 220 and a shank portion 222. The shank portion 222 has a polygonal cross-section (e.g., hexagonal) and an annular groove 224. The shank portion 222 is configured to be received and retained in a tool holder or chuck of a rotary power tool such as the drill 32.

The holder body 220 has an inner wall 232 that defines a longitudinal bore 226 for receiving the shank 106 of the bit 102. The longitudinal bore 226 includes a large diameter section 226a adjacent the front of the holder and a small diameter section 226b rearward of the large diameter section 226a. The large diameter section 226a is configured to receive and retain tool bits having a larger diameter shank, while the small diameter section 226b is configured to receive and retain tool bits having a smaller diameter shank. Each of the sections 226a, 226b is configured to generally match the cross-sectional shape of the shank 106. Like the inner wall 136 described above, each section 226a, 226b includes an inner wall having three flat wall portions 228a, 228b arranged in a triangle with three slightly concave curved wall portions 230a, 230b at corners of the triangle faulted at junctions between adjacent flat wall portions 228a, 228b.

Each section 226a, 226b also defines three windows 234a, 234b (one of each of which is shown) extending radially outward from the concave inner wall portions 230a, 230b. Each window 234a, 234b receives a retaining member in the form of a pin or a ball 236a, 236b that extends at least partially through the window 234a, 234b, into the bore sections 226a, 226b. The holder body 220 also includes a substantially cylindrical outer wall 238 with annular grooves 240a, 240b positioned at the large and small diameter sections 226a, 226b. The annular grooves 240a, 240b each receive a substantially cylindrical elastic band 242a, 242b that abuts and biases the balls 230a, 230b radially inwardly toward the bore sections 226a, 226b. The elastic bands 242a, 242b each may include a split 244a, 244b to facilitate attaching the elastic bands 242a, 242b to the holder body 220.

In use, when the shank 106 of a large diameter bit 102 is inserted into the bore 226, the flat walls 110a, 110b, 110c of the shank 102 align with the flat wall portions 228a of the large diameter section 226a of the bore 226. The rear end portion 111 of the shank 106 pushes the balls 236a of the large diameter section 226a radially outward against the force of the elastic band 242a. When the annular groove 112 of the shank 106 is aligned with the balls 230a, the elastic band 242a pushes the balls 236a radially inwardly to engage the annular groove 112. The balls 236a axially retain the bit 102 in the large diameter section 226a of the bore 226, while the flat wall portions 228a non-rotationally retain the bit 102 in the large diameter section 226a of the bore 226. Thus, rotational motion of the holder 200 can be transmitted to the bit 102 without the bit 102 moving relative to the holder 200.

When the shank 106 of a small diameter bit 102 is inserted into the bore 226, shank extends past the large diameter section 226a and the flat walls 110a, 110b, 110c of the shank 102 align with the flat wall portions 228b of the small diameter section 226b of the bore 226. The rear end portion 111 of the shank 106 pushes the balls 236b of the small diameter section 226b radially outward against the force of the elastic band 242b. When the annular groove 112 of the shank 106 is aligned with the balls 230b, the elastic band 242b pushes the balls 236b radially inwardly to engage the annular groove 112. The balls 236b axially retain the bit 102 in the small diameter section 226b of the bore 226, while the flat wall portions 228b non-rotationally retain the bit 102 in the small diameter section 226b of the bore 226. Thus, rotational motion of the holder 200 can be transmitted to the bit 102 without the bit 102 moving relative to the holder 200.

Numerous modifications may be made to the exemplary implementations described above. For example, the bore in the holder could be formed with three or more diameter sections, each having a progressively larger diameter to receive and retain multiple diameters of bit shanks. Also, each section of the bore can have a smaller or greater number of balls or pins to engage the annular groove of a bit. In addition, the geometry of the inner walls of the bore could be changed to accommodate different bit shank geometries. For example, the inner walls could be arranged in a hexagon, or could be arranged in a triangle without curved corners or junctions between the flat faces. These and other implementations are within the scope of this application.

What is claimed is:

1. A tool bit holder for releasably retaining a shank of a tool bit having three flat faces arranged generally in a triangle and an annular groove, the tool bit holder comprising:
a holder body that includes a shank-receiving bore bounded by an inner wall having three flat inner wall surfaces arranged generally in a triangle;
a plurality of windows defined in the inner wall, each window extending radially outward from the bore;
a plurality of retaining members, each retaining member received in one of the plurality of windows and extending at least partially through the window into the bore; and
an elastic band disposed around the retaining members and biasing the retaining members radially inward toward the bore,
wherein the flat wall portions of the bore are configured to engage the flat faces of the tool bit to non-rotationally retain the shank of the tool bit in the tool holder and the retaining members are configured to engage the annular groove of the tool bit to axially retain the tool bit in the tool holder.

2. The tool bit holder of claim 1, wherein the inner wall includes a concave wall surface at each junction between adjacent flat inner wall surfaces, each concave wall surface configured to engage a convex wall surface at a junction between adjacent flat faces of the tool bit.

3. The tool bit holder of claim 2, wherein each window is defined in one of the concave inner wall surfaces.

4. The tool bit holder of claim 1, wherein the windows are tapered.

5. The tool bit holder of claim 1, wherein each retaining member comprises a pin or a ball.

6. The tool bit holder of claim 1, wherein the holder body includes an outer surface with an annular recess that receives the elastic band.

7. The tool bit holder of claim 1, further comprising a shaft extending rearward from the holder body and configured to be retained in a chuck or tool bit holder of a power tool.

8. The tool bit holder of claim 7, wherein the shaft includes a polygonal shank with an annular groove.

9. A tool bit holder for releasably retaining shanks of at least two tool bits, each shank having a different diameter and each shank having three flat faces arranged generally in a triangle and an annular groove, the tool bit holder comprising:
a holder body that includes a shank-receiving bore having a front section having a larger diameter and a rear section having a smaller diameter, each section bounded by an inner wall having three flat inner wall surfaces arranged generally in a triangle;
a first window defined in the inner wall of the front section and extending radially outward from the front section of the bore;
a second window defined in the inner wall of the rear section and extending radially outward from the rear section of the bore;
a first retaining member extending at least partially through the first window into the front section of the bore;
a second retaining member extending at least partially through the second window into the rear section of the bore;
a first elastic band disposed around the first retaining member and biasing the first retaining member radially inward toward the front section of the bore; and
a second elastic band disposed around the second retaining member and biasing the second retaining member radially inward toward the rear section of the bore;
wherein the flat wall portions of the front section of the bore are configured to engage flat faces of a first tool bit of the at least two tool bits while the first retaining member engages the annular groove in the first tool bit to axially retain the shank of the first tool bit in the front section of the bore, and the flat wall portions of the rear section of the bore are configured to engage flat faces of a second tool bit of the at least two tool bits while the second retaining member engages the annular groove in the second tool bit to axially retain the shank of the second tool bit in the rear section of the bore.

10. The tool bit holder of claim 9, wherein each of the inner walls includes a concave wall surface at each junction between adjacent flat inner wall surfaces, each concave wall surface configured to engage a convex wall surface at a junction between adjacent flat faces of the tool bit.

11. The tool bit holder of claim 10, wherein each window is defined in one of the concave inner wall surfaces.

12. The tool bit holder of claim 9, wherein the windows are tapered.

13. The tool bit holder of claim 9, wherein each retaining member comprises a pin or a ball.

14. The tool bit holder of claim 9, wherein the holder body includes a first outer surface with a first annular recess that receives the first elastic band, and a second outer surface with a second annular recess that receives the second elastic band.

15. The tool bit holder of claim 9, further comprising a shaft extending rearward from the holder body and configured to be retained in a chuck or tool bit holder of a power tool.

16. The tool bit holder of claim 15, wherein the shaft includes a polygonal shank with an annular groove.

17. The tool bit holder of claim 9, wherein the first window includes a first plurality of windows and the first retaining member includes a first plurality of retaining members with each of the first plurality of windows receive one of the first plurality of retaining members.

18. A tool bit set comprising:
a tool bit having a working portion and a shank coupled to a rear end of the working portion, the shank including three flat faces arranged generally in a triangle and an annular groove; and
a tool bit holder for releasably retaining the shank of the tool bit, the tool bit holder comprising a holder body that includes a shank-receiving bore bounded by an inner wall having three flat inner wall surfaces arranged generally in a triangle, a plurality of windows defined in the inner wall, each window extending radially outward from the bore, a plurality of retaining members, each retaining member received in one of the plurality of windows and extending at least partially through the window into the bore, and an elastic band disposed around the retaining members and biasing the retaining members radially inward toward the bore, wherein the flat wall portions of the bore are configured to engage the flat faces of the tool bit to non-rotationally retain the shank of the tool bit in the tool holder and the retaining members are configured to engage the annular groove of the tool bit to axially retain the tool bit in the tool holder.

19. The tool bit set of claim 18, wherein the shank includes a convex face at each junction between adjacent flat faces, and the inner wall includes a concave wall surface at each junction between adjacent flat inner wall surfaces, each concave wall surface configured to engage one of the convex faces of the tool bit.

20. The tool bit set of claim 19, wherein each window is defined in one of the concave inner wall surfaces.
